(19) United States
(12) Patent Application Publication
(10) Pub. No.: US 2025/0256290 A1
(43) Pub. Date: Aug. 14, 2025

(54) AN APPARATUS FOR CONTINUOUS REMOVAL OF PARTICLES

(71) Applicant: VEEN HOLDINGS PTY. LTD., Bayswater North, Victoria (AU)

(72) Inventor: Tim Van der Veen, Bayswater North (AU)

(21) Appl. No.: 18/704,862

(22) PCT Filed: Oct. 26, 2022
(86) PCT No.: PCT/AU2022/051282

§ 371 Date: Apr. 25, 2024

(30) Foreign Application Priority Data
Oct. 26, 2021 (AU) 2021903418

(51) Int. Cl. B04C 5/04; B01D 46/44

(52) U.S. Cl. CPC B04C 5/04; B01D 46/44

(57) ABSTRACT

Disclosed herein is an apparatus for continuous removal of particles from a mixture of air and particles, the apparatus comprising: a separating means being configured to remove particles from the mixture of air and particles and to discharge the collected particles; a pump being configured to draw the mixture of air and particles; and a hose system having an intake at which the mixture of air and particles enters and which is configured for fluid communication between the intake, the pump and the separating means to form passages for the mixture to be drawn from the intake to the pump; wherein the apparatus is configured to be operable between a first configuration which directs the mixture to the separating device for removal and collection of particles from the mixture and a second configuration which substantially prevents the mixture from flowing to the separating means. Also disclosed is a grinding tool having said apparatus and a method of removing particles from a mixture of particles and air continuously.

### FIELD OF THE INVENTION

The present application claims priority to Australian provisional patent application no. 2021903418 entitled ‘An apparatus for continuous removal of particles’ filed on 26 Oct. 2021.

### FIELD OF THE INVENTION

The present invention generally relates to an apparatus for continuous removal of particles from a mixture of air and particles.

### BACKGROUND TO THE INVENTION

Grinding tools are typically employed to ensure floors with hard surfaces, such as wood and concrete floors, have an adequately smooth and polished surface before use. For grinding of concrete floors in commercial buildings, use of large commercial grinding tools are required. Unfortunately, the grinding is a dry process which causes fine particles as a by-product, such as concrete dust, which are a significant health hazard to an operator whether ingested, inhaled or if they collect in an operator's eyes.

Protective equipment, such as face masks, goggles and the like, can be utilised by an operator to prevent exposure to the dust. However, the concrete dust and other fine particles still present significant waste and environment hazard which must be removed from the environment itself. It can be labour intensive and therefore costly to collect and remove after the grinding process has concluded. Therefore, it is more efficient to collect the particles during the grinding process to prevent the particles being a hazard to the operator or other bystanders, and to prevent additional clean-up and removal after the grinding process.

Most grinding tools now incorporate a vacuum to suck the particles while the grinding tool is in use, and the particles are separated from the stream of air removed, via the vacuum, from the vicinity of the grinding tool at the grinding surface (see FIG. 1 (prior art)). The separated particles can then be collected into a bag, which can carry up to 20 to 30 kg of concrete dust for some commercial applications. One disadvantage of this is that, when the bag is full and must be replaced or emptied typically after about 10 to 15 minutes, the vacuum must be stopped so that the negative pressure created by the operating vacuum does not allow the dust to drop down into the disposal bag. The grinding tool must also cease operation as it cannot run without removal of concrete dust created underneath the grinding head of the grinding tool.

As the bag change-over process can take up to 3 minutes, this increases the overall time to complete the grinding task, especially where large areas are involved. Furthermore, the applicant has estimated about 12 minutes per hour or about 20% of production time is lost per hour by stopping the grinding process intermittently to remove or replace the full bags.

In addition, as dust is produced during the grinding process, the filtration system of the vacuum can become clogged and therefore reduces the suction pressure over the 10-15 period while in operation. Thus, less and less of the dust is removed over time and accordingly more and more dust is left on the floor and must be collected and cleaned up at a later stage. The grinding tool can include a separating device which can minimise this dust build-up on the vacuum by separating the dust before it reaches the vacuum filtration system via cyclonic separation thereby preventing the vacuum filtration system from being clogged (see FIG. 2 (prior art)). As the vacuum filtration system are kept in a clean state, the vacuum can provide optimal operation in the form of a constant suction pressure which provides a steady removal rate of the concrete dust at the grinding surface over the operating time of the grinding tool.

It is desirable for embodiments of the present invention to address at least partially one or more of the disadvantages of the methods or systems above. Further it is preferred that embodiments of the present invention provide an improved grinding apparatus which can reduce the time taken to polish a floor and/or improve efficiency of the grinding process.

It is to be understood that, if any prior art publication is referred to herein, such reference does not constitute an admission that the publication forms a part of the common general knowledge in the art, in Australia or any other country.

### SUMMARY OF THE INVENTION

According to an aspect of the present invention there is provided an apparatus for continuous removal of particles from a mixture of air and particles, the apparatus comprising:
a separating means being configured to remove particles from the mixture of air and particles and to discharge the collected particles;
a pump being configured to draw the mixture of air and particles; and
a hose system having an intake at which the mixture of air and particles enter and which is configured for fluid communication between the intake, the pump and the separating means to form passages for the mixture to be drawn from the intake to the pump;
wherein the apparatus is configured to be operable between a first configuration which directs the mixture to the separating device for removal and collection of particles from the mixture and a second configuration which substantially prevents the mixture from flowing to the separating means.

In an embodiment, when the apparatus is in the second configuration, the apparatus is configured to cease operation of the separating means for removal of the collected particles. When the collected particles are being removed from the separating means, the pump may operate continuously.

In an embodiment, the apparatus includes a further separating means, and, when the apparatus is in the first configuration, the apparatus is configured to cease operation of the further separating means for removal of the collected particles. When the collected particles are being removed from the further separating means, the pump may operate continuously.

The or both separating means may include an associated particle collection container, and wherein the or both separating means are configured to discharge the collected particles into the associated particle collection container. When the apparatus has ceased operation of the separating means or further separating means, the particle collection container associated therewith may be removable and replaceable while the pump is in operation.

In an embodiment, in the first configuration, the hose system is configured to form a first passage to direct the mixture from the intake to an inlet of the separating means and from the outlet of the separating means to the pump for separating and collecting particles from the mixture wherein, in the second configuration, the hose system is configured to form a second passage which diverts the mixture away from the separating means. The second passage may bypass the separating means. The second passage may direct the mixture from the intake to the pump directly. The second passage may direct the mixture from the intake to the or a further separating means.

The apparatus can further comprise at least one valve, wherein in the first configuration, the at least one valve is arranged to direct the mixture to through the first passage and in the second configuration the at least one valve is arranged to direct the mixture to through the second passage. The apparatus can also further comprise a junction member being arranged between the intake and the separating means for fluid communication of the intake and the first and second passages.

The apparatus can comprise a pair of valves, one of the valves being arranged on either side of the junction member, wherein in the first configuration, a first valve at an inlet of the separating means on one side of the junction member is configured to be open and the second valve on the other side of the junction member is configured to be closed thereby forming the first passage. In the second configuration, the second valve can be configured to be open and the first valve is configured to be closed thereby forming the second passage.

The apparatus can comprise a further junction member is arranged between the outlet of the separating means and an inlet of the pump such that the inlet of the pump and the first and second passages are in fluid communication.

In an embodiment, the separating means or further separating means or both include an outlet valve, wherein the outlet valve has the same condition as the valve at the inlet of the respective separating means. The valves may be butterfly valves. The apparatus can further comprise a controller for operating the valves.

According to another aspect of the present invention there is provided an apparatus for allowing particles to be removed continuously from a mixture of air and particles, the apparatus comprising:
a pair of separating means, each separating means configured to remove particles from the mixture of air and particles and to discharge the collected particles;
a pump configured to draw the mixture of air and particles;
a system of hoses which connect the pump and the pair of separating means forming passages which allow the mixture to flow therebetween;
wherein the apparatus is operable between a first configuration and a second configuration;
wherein, in the first configuration, the apparatus is configured to allow the mixture to flow to the pump through one separating means for removal of particles from the mixture and a second configuration wherein the apparatus is configured to allow the mixture to flow to the pump through the other separating means for removal of particles from the mixture.

Each of the separating means can include a particle collection container, and wherein the separating means is configured to discharge the collected particles into the respective particle collection container. When the apparatus is in the first configuration, the apparatus can be configured to allow ceasing of operation of one separating means for removal of the collected particles while the pump is in operation, and wherein, when the apparatus is in the second configuration, the apparatus can be configured to allow ceasing of operation of the other separating means for removal of the collected particles while the pump is in operation. The pump can be a vacuum pump.

In an embodiment, the or both separating means are configured to separate the particles from the mixture by density separation. The or both separating means can be configured to separate the particles from the mixture by cyclonic separation. The separating means or both separating means can be configured to separate the particles from the mixture by filtration.

According to yet another aspect of the present invention there is provided grinding tool for grinding a surface, the tool incorporating an apparatus as described above.

According to a further aspect of the present invention there is provided a method of removing particles from a mixture of particles and air continuously, the method comprising use of the apparatus as described above.

According to another further aspect of the present invention there is provided a method of removing particles from a mixture of particles and air continuously, the method comprising the steps of:
providing a hose system which is configured for fluid communication between an intake of the hose system, pump and a separating means wherein the separating means is configured to remove particles from the mixture of air and particles and to discharge the collected particles;
operating the pump to draw the mixture from the intake of the hose system towards the pump;
controlling valve means to adopt a first configuration wherein the mixture is drawn from the intake to the separating means for removal of particles from the mixture; and controlling the valve means to adopt a second configuration wherein the mixture is substantially prevented from flowing through the separating means for allowing the collected particles accumulated by the separating means to be removed while the pump is operating.

When, in the second configuration, the method includes the step of drawing the mixture through a further separating means for removal of particles of the mixture and substantially preventing the mixture from flowing through the first afore-mentioned separating means. When in the first configuration, drawing the mixture through the first separating means for removal of particles of the mixture can include allowing the collected particles accumulated by the further separating means to be removed while the pump is operating.

### BRIEF DESCRIPTION OF THE DRAWINGS

One or more embodiments of the present invention will hereinafter be described with reference to the accompanying Figures, in which:

FIG. 1 is a view of a prior art grinding tool with a vacuum pump;

FIG. 2 is a view of a prior art grinding tool with separating means and a vacuum pump;

FIG. 3 is a view of a hose system and separating means of an apparatus for continuous removal of particles from a mixture of air and particles according to a preferred embodiment of the present invention; and

FIG. 4 is a view of another apparatus having a hose system and a pair of separating means for continuous removal of particles from a mixture of air and particles according to another preferred embodiment of the present invention.

### DETAILED DESCRIPTION OF THE DRAWINGS

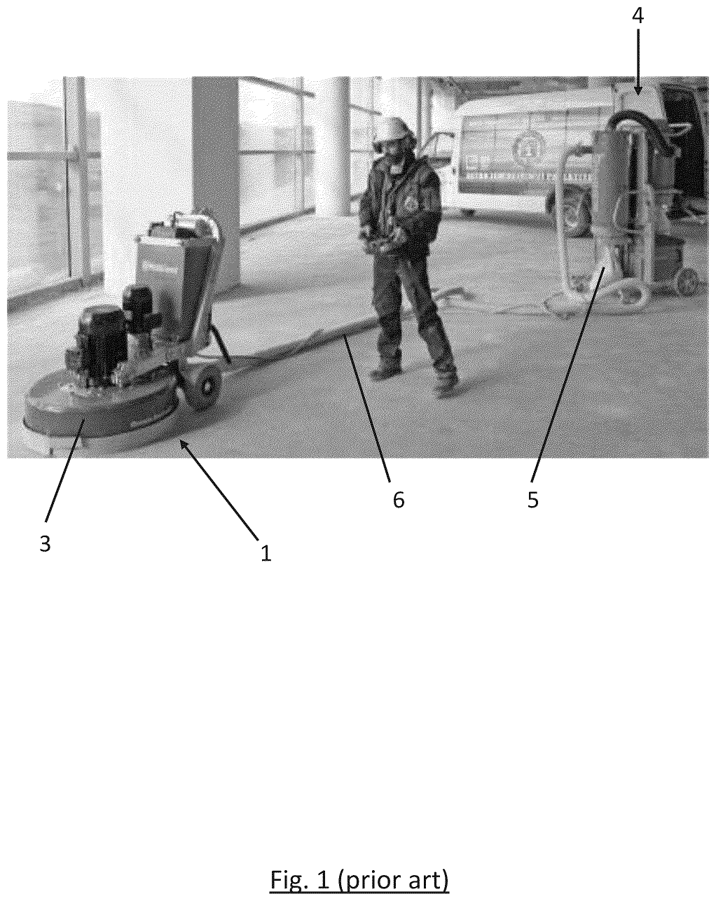

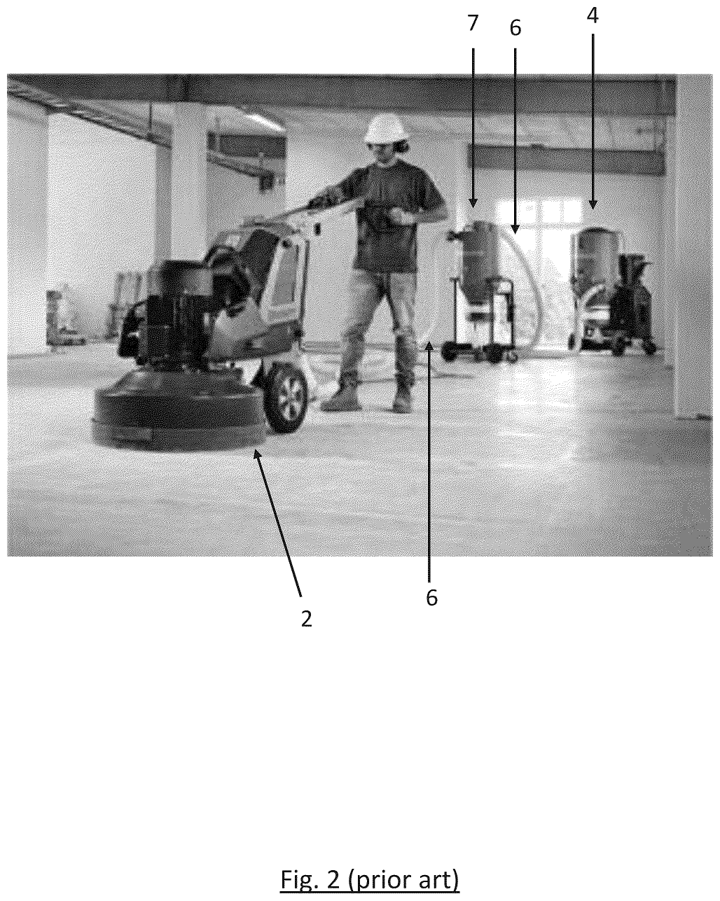

For illustration of FIGS. 1 and 2, there are shown prior art grinding tools 1, 2 having a grinding head 3, a vacuum pump 4 and its associated bag 5 connected to the grinding tool 2 by a hose 6. The prior art grinding tool 2 also has a separator 7 connected by hoses 6 between the tool 2 and vacuum pump 4, which allows collection of particles from the mixture of air and particles before the mixture reaches the pump 4.

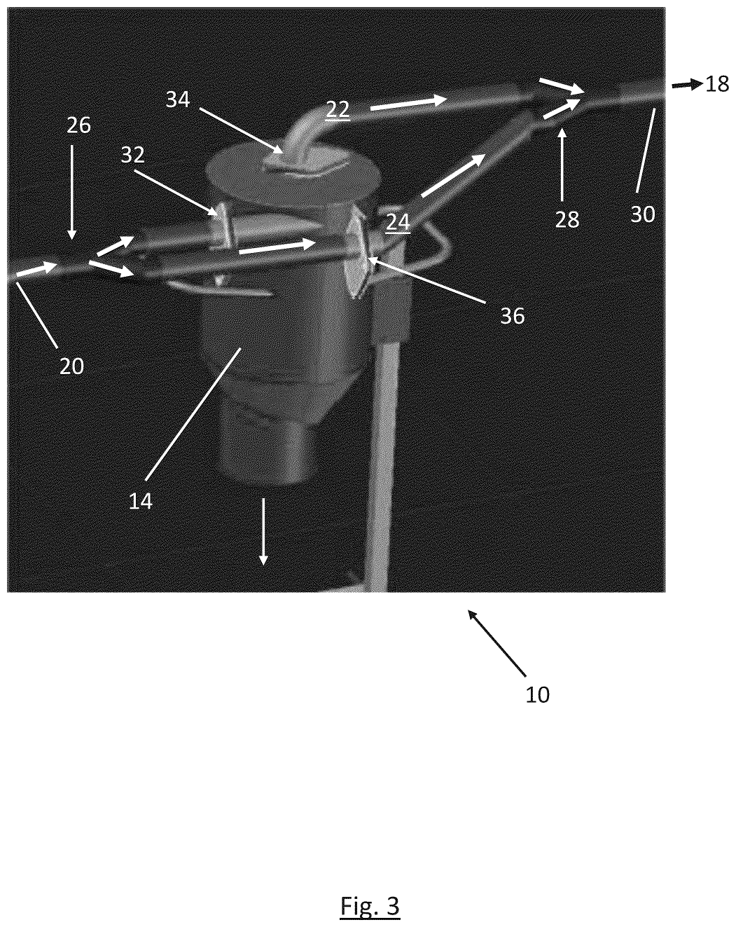

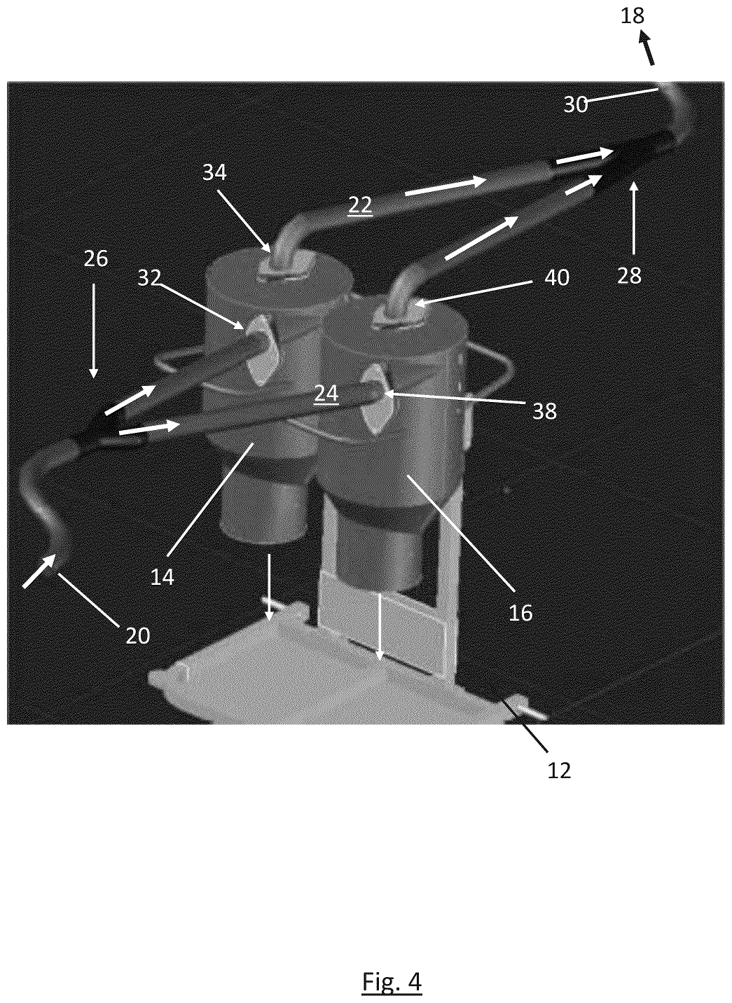

Referring now to FIGS. 3 and 4, there is shown apparatus 10, 12 for continuous removal of particles from a mixture of air and particles according to preferred embodiments of the present invention.

The apparatus 10, 12 has at least one separating means 14 which is configured to remove particles from the mixture and to discharge the collected particles, typically into a particle collection or waste container, such as a bag or the like (not shown). FIG. 3 shows an apparatus 10 according to one embodiment having one separating means while FIG. 4 shows an apparatus 12 have a pair of separating means 14, 16 according to a preferred embodiment.

The apparatus 10, 12 also has a pump 18 which is configured to produce a negative pressure which ‘sucks’ up the mixture of air and particles and draws the mixture from an intake 20 of a hose system towards the pump 18. The hose system connects the at least one separating means 14, the pump 18 and the intake 20 such that they are in fluid communication and forms passages 22, 24 to allow the mixture to be drawn by the pump 18 from the intake 20 towards the pump 18.

The intake 20 of the hose system can be connected to any environment where particles are located or produced and can mix with air to form the air and particle mixture. In the examples shown in FIGS. 1 and 2, the particles are produced by grinding tools for concrete floors and accordingly the intake 20 is connectable to a grinding tool near the grinding surface where the intake allows the drawing the air and particle mixture away from the grinding surface. However, it would be appreciated that the intake 20 could be located at or connected to other machinery or tools where particles, particularly fine particles, are produced, such as tools for polishing, cutting, sawing, sanding, jigsaws and the like.

The apparatus has a valve means which can be operable between first and second configurations so as to direct the mixture through the passages 22, 24 formed by hoses in the hose system in the direction indicated by the arrows in FIGS. 3 and 4. In the first configuration, the mixture can be directed to the separating means 14 along a first passage 22 so as to allow the removal and collection of the particles of the mixture entering the separating means 14 and the collected particles can be discharged into the particle collection container i.e. the bag, associated with the separating means 14.

In the second configuration as exemplified in FIG. 3, the mixture is substantially prevented from being directed to the separating means 14 effecting bypass of the mixture away from the separating means 14 via a second passage 24. When the mixture is no longer directed to the separating means 14, the separating means 14 can cease operation so as to allow a full bag of collected particles can be removed and replaced with an emptied or fresh bag at the separating means 14. Once the bag has been replaced with an empty one, the separating means 14 can commence effective operation again.

Therefore, the apparatus 10, 12, advantageously, when in the second configuration, allows for continuous removal of the particles at the intake of the apparatus 10 whilst the pump 18 is operating continuously yet allows for the particle collection container at the separating means 14 to be replaced and emptied. Thus, the process of grinding the surface is able to operate continuously and thus reduces the time to grind the floor as there is no requirement to cease operation of the grinding tool for exchange or replacement of the full particle collection container with empty ones.

In the embodiment of FIG. 3 the mixture is drawn through the second passage 24 directly from the intake 20 to the pump 18 and this does cause some of the particles to be collected at the pump filtration system however the accumulation of particles is minimal as the time taken to remove the particle collection container and replace it with a fresh or emptied container is greatly reduced. For smaller grinding tools, such as those for residential or small commercial applications, having a single separating device is preferred for a more compact arrangement which is manoeuvrable within a smaller area. Furthermore, a smaller grinding tool will produce less particles, and thus only a small number of particles will accumulate in the pump filtration system while the separating means 14 has ceased operation and the particle collection container is exchanged or emptied. This results in only a minimal loss of suction due to light clogging of the pump filtration system.

In the preferred example illustrated in FIG. 4, the mixture is directed to a separating means 14 via the first passage 22 when the valve means is in the first configuration. However, when the valve means is manipulated into the second configuration the mixture is drawn from the intake to the pump 18 via a second separating means 16 so as to allow the removal and collection of the particles of the mixture entering the second separating means 16 and the collected particles can be discharged into the particle collection container i.e. the bag, associated with the second separating means 16. This embodiment exemplified in FIG. 4 advantageously also allows for continuous operation of the pump 18 to continuously draw the mixture of air and particles and in addition, to bypass one of the two separating means 14, 16 when its particle collection container requires replacement or emptying by ceasing operation of the separating means 14, 16 where its container is being replaced or exchange.

Having two separating means 14, 16 is advantageously for large commercial applications, as the grinding tools are typically more powerful and therefore large numbers of particles are produced. Therefore, by allowing the mixture to be directed between one or the other of the separating means 14, 16 allows constant collection of the particles before this reaches the vacuum filtration system, and therefore there is no or minimal clogging of the vacuum filtration system which results in maximum suction power over the entire grinding time. Furthermore, the process of grinding the surface is able to operate continuously and thus reduces the time to grind the floor as there is no requirement to cease operation of the grinding tool for exchange or replacement of the full particle collection container with empty ones at either of the separating means 14, 16.

The direction of the mixture of air and particles is preferably conducted by the apparatus 10, 12 having arranging the apparatus 10 to further comprise a junction member 26 between the intake 20 and the separating means 14, 16. The junction member 26 allows fluid communication between the intake 20 and the first and second passages 22, 24 and the valve means operate in a first configuration to direct the mixture to be drawn through one passage on one side of the junction member 26, i.e. the first passage 22 and when the valve means is manipulated into the second configuration the mixture is directed to be drawn through the other passage on the other side of the junction member 26, i.e. the second passage 24.

The apparatus 10, 12 can also have a second junction member 28 which is arranged between the separating means 14 and the inlet 30 to the pump 18 which allows the inlet 30, and first and second passages 22, 24 to be in fluid communication. Specifically, the second junction member 28 allows the mixture from either passage 22, 24 to be drawn to the pump 18.

The embodiments illustrated in FIG. 3 show a pair of valves 32, 34 at an inlet and outlet of the first separating means 14, and a valve 36. When in the first configuration, the valves 32, 34 are open and the valve 36 is closed to allow the mixture to be directed through the first passage and the separating means 14 for collecting the particles. When the particle collection container (not shown) is full, the conditions of the valves 32, 34, 36 can be reversed, i.e. valves 32, 34 are closed and valve 36 is open to allow the mixture to bypass the first separating means 14 so that operation of the separating means 14 can cease for exchange or replacement of the particle collection container while allowing the continual operation of the pump 18.

Similarly, as exemplified in the embodiment of FIG. 4, the apparatus 12 comprising an additional pair of valves 36, 38 at the inlet and outlet respective of further separating means 16. When in the first configuration, the valves 32, 34 are open and the valves 38, 40 is closed to allow the mixture to be directed through the first passage and the separating means 14 for collecting the particles and allows the mixture to bypass the second separating means 16 so that operation of the separating means 16 can cease for exchange or replacement of its associated particle collection container while allowing the continual operation of the pump 18. When the particle collection container (not shown) of the separating means 14 is full, the conditions of the valves 32, 34, 38, 40 can be reversed, i.e. valves 32, 34 are closed and valve 38, 40 are open to allow the mixture to bypass the first separating means 14 so that operation of the separating means 16 can cease for exchange or replacement of the particle collection container while allowing the continual operation of the pump 18.

Although the apparatus 10, 12 have preferred arrangements with multiple valves, it can be understood by a person skilled in the art that only a single valve may be required to divert the mixture at a junction from one passage to the other, and that the location of the valve may be at any of the locations indicated, i.e. at the inlet of the separating means 14, 16, at any point of the hose system or within either or both of the junction members 26, 28. However use of multiple valves are preferred to prevent any potential and inadvertent loss of suction, to act as redundancy and to promote optimal sealing of the separating means 14, 16.

The separating means 14, 16 can be one of a number of different types of separating means including a cyclonic separator or a density separator or a separator which operates by mechanical means such as a filter and the like. The apparatus 10, 12 can also include a controller (not shown) which can allow an operator, by wired means, wirelessly or remotely, to switch the apparatus 10, 12 between the two configurations, i.e. manipulate the valve conditions, to bypass the separating means 14 or to select between separating means 14, 16 when the particle collection container require exchange or emptying. The valves 32, 34, 36, 38, 40 can be of any type known to a person skilled in the art which have members which are slidable, movable or rotatable so as to permit or obstruct passage therethrough of the mixture. In preferred embodiments, the valves are butterfly valves.

There is also provided a method of removing particles from a mixture of particles and air continuously according to another preferred embodiment of the present invention. The steps of this method include having an apparatus 10, 12 as described above being connected to a grinding tool. The intake of the hose system is placed near the grinding surface for optimal removal of the particles produced by drawing the mixture away towards the pump 18. By operating the apparatus 10, 12 in one configuration, the mixture is drawn through a first passage 22 during the grinding process where the separating means 14 is configured to remove particles from the mixture of air and particles and to discharge the collected particles into a particle collection container.

When the particle collection container is full, the operator can operate the apparatus 10 to control the valve(s) to adopt the second configuration wherein the mixture is substantially prevented from flowing through the separating means 14, i.e. through the second passage 24, to cease operation of the separating means 14 so that the collected particles accumulated by the separating means 14 can be removed while the pump is operating. In this way, the grinding tool can be operated continuously while the particle collection container is exchanged or emptied.

Alternatively, if the apparatus 12 is in use which has a second separating means 16, the operator can operate the apparatus 12 to control the valve(s) to adopt the second configuration wherein the mixture is substantially prevented from flowing through the separating means 14 to cease operation of the separating means 14 so that the collected particles accumulated by the separating means 14 can be removed while the pump is operating. Thus, the operator can easily switch between selected use of either separating means 14, 16 to allow continuous operation of the grinding tool and to be able to select bypass of one of the separating means 14, 16 where its associated particle collection container requires exchange or replacement.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention

1. An apparatus for continuous removal of particles from a mixture of air and particles, the apparatus comprising:
a separating device being configured to remove particles from the mixture of air and particles and to discharge collected particles;
a pump being configured to draw the mixture of air and particles; and
a hose system having an intake at which the mixture of air and particles enters and which is configured for fluid communication between the intake, the pump and the separating device to form passages for the mixture to be drawn from the intake to the pump;
wherein the apparatus is configured to be operable between a first configuration which directs the mixture to the separating device for removal and collection of particles from the mixture and a second configuration which substantially prevents the mixture from flowing to the separating device.

2. An apparatus according to claim 1, wherein, when the apparatus is in the second configuration, the apparatus is configured to cease operation of the separating device for removal of the collected particles.

3. An apparatus according to claim 2, wherein, when the collected particles are being removed from the separating device, the pump is operating continuously.

4. An apparatus according to claim 1, wherein the apparatus includes a further separating device, and, when the apparatus is in the first configuration, the apparatus is configured to cease operation of the further separating means device for removal of the collected particles.

5. An apparatus according to claim 4, wherein, when the collected particles are being removed from the further separating device, the pump is operating continuously.

6. An apparatus according to claim 3, wherein the separating device includes an associated particle collection container, and wherein the separating device is configured to discharge the collected particles into the associated particle collection container.

7. An apparatus according to claim 6, wherein, when the apparatus has ceased operation of the separating device, the particle collection container associated with the separating device is removable and replaceable while the pump is in operation.

8. An apparatus according to claim 1, wherein, in the first configuration, the hose system is configured to form a first passage to direct the mixture from the intake to an inlet of the separating device and from an outlet of the separating device to the pump for separating and collecting particles from the mixture wherein, in the second configuration, the hose system is configured to form a second passage which diverts the mixture away from the separating device.

9. An apparatus according to claim 8, wherein the second passage bypasses the separating device.

10. An apparatus according to claim 8, wherein the second passage directs the mixture from the intake to the pump directly or wherein the second passage directs the mixture from the intake to a further separating device.

11. (canceled)

12. An apparatus according to claim 8, further comprising at least one valve,
wherein, in the first configuration, the at least one valve is arranged to direct the mixture to through the first passage, and
wherein, in the second configuration, the at least one valve is arranged to direct the mixture to through the second passage.

13. An apparatus according to claim 12, further comprising a junction member being arranged between the intake and the separating device for fluid communication of the intake and the first and second passages.

14. An apparatus according to claim 13, comprising a pair of valves, one of the valves being arranged on either side of the junction member, wherein in the first configuration, a first valve at an inlet of the separating device on one side of the junction member is configured to be open and the second valve on the other side of the junction member is configured to be closed thereby forming the first passage.

15. An apparatus according to claim 14, wherein, when in the second configuration, the second valve is configured to be open and the first valve is configured to be closed thereby forming the second passage.

16. An apparatus according to claim 15, wherein a further junction member is arranged between the outlet of the separating device and an inlet of the pump such that the inlet of the pump and the first and second passages are in fluid communication.

17. (canceled)

18. An apparatus according to claim 14, wherein the valves are butterfly valves.

19-23. (canceled)

24. An apparatus according to claim 1, wherein the separating device is configured to separate the particles from the mixture by one or more of the following: density separation, cyclonic separation, and filtration.

25-26. (canceled)

27. A grinding tool for grinding a surface, the tool incorporating an apparatus according to claim 1.

28. (canceled)

29. A method of removing particles from a mixture of particles and air continuously, the method comprising:
providing a hose system which is configured for fluid communication between an intake of the hose system, a pump, and a separating device, wherein the separating device is configured to remove particles from the mixture of air and particles and to discharge collected particles;
operating the pump to draw the mixture from the intake of the hose system towards the pump;
controlling a valve device to adopt a first configuration wherein the mixture is drawn from the intake to the separating device for removal of particles from the mixture; and
controlling the valve device to adopt a second configuration wherein the mixture is substantially prevented from flowing through the separating device for allowing the collected particles accumulated by the separating device to be removed while the pump is operating.

30-31. (canceled)

32. An apparatus according to claim 5, further comprising a particle collection container associated with the further separating device, wherein, when the apparatus has ceased operation of the further separating device, the particle collection container associated with the further separating device is removable and replaceable while the pump is in operation.
